(19) United States
(12) Patent Application Publication
(10) Pub. No.: US 2014/0374386 A1
(43) Pub. Date: Dec. 25, 2014

(54) METHOD AND DEVICE FOR FORMING NANO PARTICLE

(71) Applicant: Samsung Electro-Mechanics, Co., Ltd., Suwon (KR)

(72) Inventors: Sung Ho LEE, Suwon (KR); Hee Bum LEE, Suwon (KR); Jung Wook SEO, Suwon (KR)

(73) Assignee: Samsung Electro-Mechanics, Co., Ltd., Suwon (KR)

(21) Appl. No.: 14/029,244

(22) Filed: Sep. 17, 2013

(30) Foreign Application Priority Data
Jun. 21, 2013 (KR) 10-2013-0071713

(51) Int. Cl. B01J 19/08

(52) U.S. Cl. CPC B01J 19/088; Y10S 977/775; B82Y 40/00
USPC 219/72; 219/121.11; 219/121.6; 977/775

(57) ABSTRACT

There is provided a method of forming a nanoparticle including: preparing a wire formed of a material for forming a nano-sized particle; connecting the wire to first and second electrodes; pre-heating the wire using a pre-heating device; and applying energy to the wire using a power supply to form the nano-sized particle, wherein after the pre-heating is performed, a skin depth of the wire is larger than a radius of the wire.

### CROSS-REFERENCE TO RELATED APPLICATIONS

This application claims the priority of Korean Patent Application No. 10-2013-0071713 filed on Jun. 21, 2013, in the Korean Intellectual Property Office, the disclosure of which is incorporated herein by reference.

### BACKGROUND OF THE INVENTION

1. Field of the Invention

The present invention relates to a method and device for forming a nanoparticle.

2. Description of the Related Art

In accordance with the high degree of industrial integration, technology has evolved such that elements and components of devices are able to be formed to be small, a lightweight, and to have high strength.

One of alternative for forming such elements and components is for the manufacturing thereof using particles having a nano-sized diameter.

Generally, a nanoparticle has a diameter of 1 nm to several hundred nms, and a material manufactured using such a nanoparticle often shows unique physical properties that may not be evident in existing materials, even in the case that they have the same chemical composition and physical crystal structure.

Due to the unique physical properties of the nanoparticle, the nanoparticle has a lot of industrial potential in fields such as the electronic components field, the life sciences and materials field, the medical field, the national defense field, the energy field, the environmental materials field, and the like, and has been commercialized in some of the above-mentioned fields, such that the value thereof has been confirmed.

Unlike these positive aspects, there are also problems to be solved in terms of the nanoparticle, due to the extremely small size thereof.

Typical examples of the problems include difficulties in dispersion due to a very large specific surface area, a chemical stability problem associated with oxidation of the particle, a problem in which it is difficult to obtain particles having a uniform size in a manufacturing process, and the like.

A method of synthesizing nanoparticles may mainly be divided into a physical method and a chemical method.

As the physical method, there may be provided a mechanical grinding method of grinding a bulk into small powder particles in a top-down scheme, and an agglomerating method of melting and then agglomerating a target metal using heat or an electron beam in a bottom-up scheme.

In the case of the mechanical grinding method, alloy nano powder particles configured of several components may be easily manufactured; however, physical properties thereof may be changed due to an intrusion of impurities caused by friction between a ball and a container and the synthesis of nano powder particles having a high dislocation density that may be generated during a process.

Further, at the time of manufacturing a nanoparticle, since there is a risk that an undesired oxide may be created due to exposure of a surface thereof to oxygen, an inert atmosphere should be maintained.

A typical example of the agglomerating method is a plasma vapor method.

The plasma vapor method may be applied to all materials. Particularly, the plasma vapor method may even be applied to a high melting point and lower vapor pressure material that is difficult to be implemented by other methods.

The plasma vapor method is a method of emitting a high temperature plasma flame, having a temperature of tens of thousands of degrees Celsius (° C.), created by a plasma gun, to heat and evaporate a raw material, and the plasma classified as DC plasma or RF plasma, according to a kind of a power supply device.

Generally, a device for forming RF plasma does not have an electrode and includes a discharging part disposed within a quartz pipe having a coil wound around an outer surface thereof, such that pollution does not occur. However, there may be difficulties in commercializing the production of RF plasma, such as a high equipment costs.

Unlike this, DC plasma, formed using a method of generating an arc using electrodes such as an anode and a cathode to melt a raw material, has the possibility that pollution will occur due to the electrodes.

However, DC plasma is more advantageous than RF plasma in terms of equipment costs.

However, the plasma vapor method generally has disadvantages in that a manufacturing device and raw materials used therein are relatively expensive, distribution of formed particles is non-uniform, such that the particles need to be distributed, and energy consumption efficiency may be very low.

The chemical method has advantages in that an amount of applied energy may be small, since energy accompanied with a chemical reaction may be utilized, a speed of synthesis may be rapid, and a uniform reaction control may be performed, but has disadvantages such as pollution by impurities, risks from chemical materials used therein, and may cause environmental problems.

The chemical method may be divided into a vapor-phase reaction, a liquid-phase reaction, and a solid-phase reaction according to a region in which a reaction occurs.

A typical example of a vapor method includes an aerosol method, a reaction method of allowing gases to react with each other or allowing a droplet and a gas to react with each other and is also known as a combustion synthesis method or a frame synthesis method.

A typical example of a liquid-phase synthesis method, a widely used method, includes a nominal method, a sol-gel method, a hydrothermal method, and the like.

These methods may easily allow for a reaction observation to be performed and controlled in a liquid phase as compared with other methods and allow powder particles having uniformity and high purity to be manufactured, but have disadvantages such as a strong cohesiveness of a particle and a slight non-uniform shape.

Particularly, in a precipitation method, a method of manufacturing metal or oxide powder particles by adding a precipitant or a reducing agent to an aqueous solution of a metal salt or obtaining a metal or an oxide from a melted salt by a chemical method, characteristics of the powder particles are changed depending on formation conditions.

A size and a shape of the particle formed by the precipitation method are determined by a degree of saturation.

When the degree of saturation is low, the particles have a coarse size and a crystalline structure in a polyhedral shape, and when the degree of saturation is high, the particles have a small size and a crystalline structure and are non-uniformly formed.

According to the related art, as a method of synthesizing nanoparticles at the time of mass production of the nanoparticles, a chemical synthesis method has mainly been used.

However, in terms of the advancement of industry and environmental pollution, the chemical synthesis method has disadvantages such as pollution by impurities, the generation of a chemical byproducts such as a waste solution, a risk of treating a chemical material, and the like.

Therefore, in order to substitute for the chemical synthesis method, there is a need to develop an environmentally-friendly system capable of mass-producing nano powder particles by using a vapor method.

As a method capable of substituting for the chemical synthesis method, there is a physical method using a plasma heating method, a pulsed wire discharge (PWD) method, or the like.

Particularly, the pulsed wire discharge method, a method of manufacturing nanoparticles by instantaneously discharging a current charged in a capacitor as a high voltage and a high current to evaporate and agglomerate a wire, is appropriate for manufacturing nano powder particles having a size of 50 to 150 nm.

The pulsed wire discharge method has an advantage in that it may be applied to all metals and alloys that may be used to form a wire, but has problems such as explosion of a non-uniform wire, an agglomeration phenomenon of generated particles in accordance with an increase in the number of nanoparticles, a temperature increase in an atmospheric gas due to heat at the time of an explosion, formation of a non-uniform core due to a change in a solvent temperature, formation of nanoparticles having a wide particle size distribution due to a formation speed, and the like.

Therefore, a nanoparticle forming device capable of solving the problems of the pulsed wire discharge method and forming nanoparticles having a uniform particle size distribution by applying a uniform amount of electrical energy to a wire has been demanded.

The following Related Art Document (Patent Document 1) relates to a radial pulsed arc discharge gun for synthesizing nano powder particles.

Patent Document 1 does not disclose a pre-heating step as disclosed in the present invention and does not also disclose that a depth of a skin of a wire is large a radius of the wire.

### RELATED ART DOCUMENT

(Patent Document 1) Korean Patent Laid-Open Publication No. 2005-0023301

### SUMMARY OF THE INVENTION

An aspect of the present invention provides a method and device for forming a nanoparticle allowing for uniformly distributed particles.

According to an aspect of the present invention, there is provided a method of forming a nanoparticle including: preparing a wire formed of a material for forming a nano-sized particle; connecting the wire to first and second electrodes; pre-heating the wire using a pre-heating device; and applying energy to the wire using a power supply to form the nano-sized particle, wherein after the pre-heating is performed, a skin depth of the wire is greater than a radius of the wire.

In the pre-heating, in the case that the radius of the wire is 0.15 mm, the wire may be pre-heated to a temperature of 0.8 Tm.

In the pre-heating, in the case that the radius of the wire is 0.10 mm, the wire may be pre-heated to a temperature of 0.3 to 0.8 Tm.

The applying of the energy to the wire using the power supply to form the nano-sized particle may be performed by applying energy having a frequency of 1 MHz.

The applying of the energy to the wire using the power supply to form the nano-sized particle may be performed under a nitrogen, oxygen, or inert gas atmosphere.

The wire may be a metal or a semiconductor.

According to another aspect of the present invention, there is provided a device for forming a nanoparticle including: a wire formed of a material for forming a nano-sized particle; first and second electrodes electrically connected to the wire; a power supply electrically connected to the first and second electrodes and applying energy to the wire; and a pre-heating device pre-heating the wire, wherein a skin depth of the wire is larger than a radius of the wire.

In the case that the radius of the wire is 0.15 mm, a temperature of the wire may be 0.8 Tm.

In the case that the radius of the wire is 0.10 mm, a temperature of the wire may be 0.3 to 0.8 Tm.

The pre-heating device may be at least one of a laser device, an infrared ray device, a coil, and a resistor.

The energy applied from the power supply may have a frequency of 1 MHz.

The wire may be a metal or a semiconductor.

The device may further include a gas chamber sealing the wire.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic flow chart of a method of forming a nanoparticle according to an embodiment of the present invention;

FIG. 2 is a cross-sectional view of a wire; and

FIG. 3 is a schematic configuration diagram of a device for forming a nanoparticle according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

The term “skin effect,” used herein, refers to a phenomenon in which electricity flows along a surface of a conductor, and a depth at which the electricity flows from the surface of the conductor is referred to as skin depth.

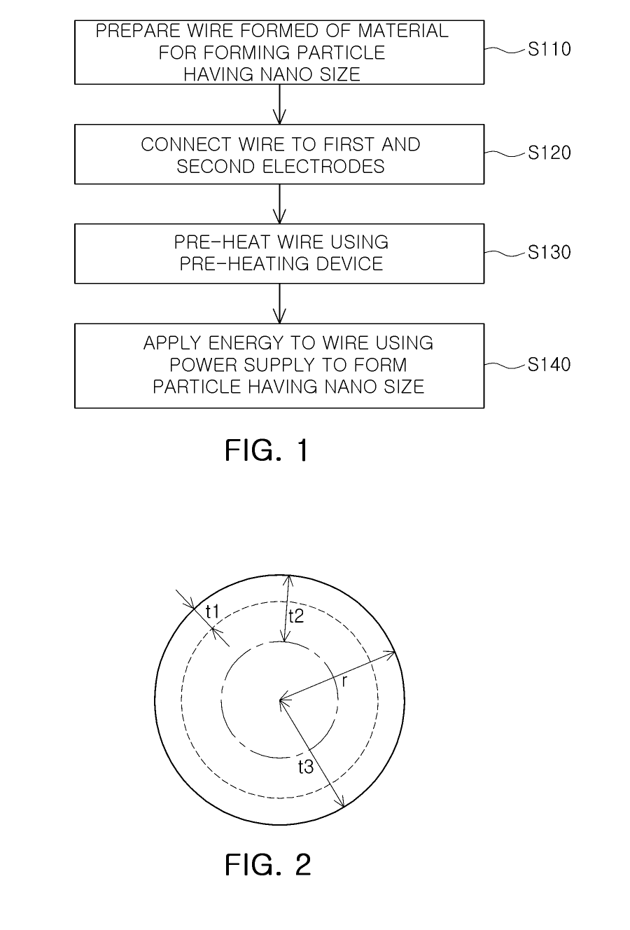

FIG. 1 is a schematic flow chart of a method of forming a nanoparticle, according to an embodiment of the present invention.

The method of forming a nanoparticle according to the embodiment of the present invention will be described with reference to FIG. 1. The method of forming a nanoparticle according to the embodiment of the present invention may include: preparing a wire formed of a material for forming a nano-sized particle (S110); connecting the wire to first and second electrodes (S120); pre-heating the wire using a pre-heating device (S130); and applying energy to the wire using a power supply to form the nano-sized particle (S140), wherein after the pre-heating is performed, a skin depth of the wire is larger than a radius of the wire.

In the method of forming a nanoparticle, the preparing of the wire formed of the material for forming the nano-sized particle (S110) will be first described.

The wire may have a thin cylindrical shape and have a form in which a length thereof is significantly longer than a diameter thereof.

The wire may be formed of a material in which electricity may flow, more specifically, a material such as copper, silver, gold, or the like, but is not limited thereto.

Particularly, in the method of forming a nanoparticle, a nanoparticle of a semiconductor material may be manufactured using the semiconductor material.

In order to form the nanoparticle by a pulsed wire discharge method, electricity should be able to flow through the wire so that very large amount of energy is instantaneously applied to the wire.

Since the semiconductor material has properties close to those of a non-conductive material at normal temperatures, the nanoparticle of the semiconductor material may not be able to be formed using a general pulsed wire discharge method.

However, since the method of forming a nanoparticle according to the embodiment of the present invention includes pre-heating the wire, the semiconductor material may be manufactured in a wire form to form the nanoparticle.

Generally, in the case of a metal, as a temperature increases, vibrations of a crystal lattice increase to impede the flow of electrons, such that resistance increases. However, in the case of a semiconductor, since an amount of electrons moving up to a conduction band through thermal energy may increase at a predetermined temperature or more, resistance may be decreased.

That is, since the method of forming a nanoparticle according to the embodiment of the present invention includes pre-heating the wire, the nanoparticle of the semiconductor material may be formed.

Therefore, the wire may be a metal or a semiconductor.

In the case in which the wire is the metal, the wire may be at least one of copper, aluminum, silver, and gold, but is not limited thereto.

In the case in which the wire is the semiconductor, the wire may be at least one of silicon, gallium arsenide, and indium phosphide, but is not limited thereto.

When it is assumed that a radius of the wire is r, r may be 0.1 to 1.5 mm.

Next, the connecting of the wire to the first and second electrodes (S120) may be performed.

The first and second electrodes may have a capacitor connected to a power supply device, respectively.

The capacitor may be to be charged with a high voltage and a high current and then allow the high voltage and the high current to instantaneously flow to the wire.

After the wire is connected to the electrode, the pre-heating of the wire using the pre-heating device (S130) may be performed. Then, the applying of the energy to the wire using the power supply to form the nano-sized particle (S140) may be performed.

In the pre-heating (S130), the wire may be pre-heated using a laser device, an infrared ray device, a coil, a resistor, and the like.

The electricity flowing through the wire may flow along a surface of a conductor.

A phenomenon in which electricity flows along the surface of the conductor as described above is known as a skin effect, and a depth at which the electricity flows from the surface of the conductor is known as a skin depth.

Referring to FIG. 2, when the electricity flows in the wire, it may flow from a surface of the wire to a depth corresponding to t1 at a normal temperature.

That is, in the applying of the energy (S140), since most of the energy flows through the depth of t1 of the wire, when explosion occurs in the wire due to the application of the energy, the explosion may mainly occur at the surface of the wire.

Since a difference in applied energy may be significantly large, depending on the depth of the wire, a size distribution of the formed nanoparticle may be very wide and an amount of nanoparticles that may be obtained with respect to a mass of the wire used may be very small.

However, when a temperature of the wire is increased due to pre-heating the wire, the electricity flowing along the wire may flow from the surface of the wire to a depth t2.

That is, a difference in applied energy depending on the depth of the wire may decrease and an amount of nanoparticles that may be obtained with respect to a mass of the used wire may be increased, as compared with a normal temperature.

As a result, in order to apply a constant amount of energy from the surface of the wire up to the center of the wire, the skin depth of the wire needs to be larger than that the radius of the wire.

That is, in the case in which the skin depth increases as in t3 of FIG. 2, since the electricity flows along the entire wire in the applying of the energy (S140), the nano-sized particles may become uniform and an amount of nanoparticles that may be obtained may rapidly increase.

A detailed description thereof will be provided below.

In the case of a metal, as a temperature increases, a specific resistance value may increase. Here, the specific resistance value may have an effect on the skin depth.

The specific resistance value depending on the temperature may be determined by the following Equation 1.

ρ(T)=ρ₀[1+α(T−T₀)]

In the above Equation 1, ρ is a specific resistant, ρ₀ is a specific resistance at a normal temperature, T is a measurement temperature, T₀ is a normal temperature, and α is a resistant temperature coefficient.

Generally, since α of the metal is larger than 0, as a temperature increases, the specific resistance of the metal may increase.

The reason for which the specific resistance of the metal increases as the temperature increases is that as the temperature of the metal increases, vibrations in a lattice thereof increase to thereby impede movement of free electrons.

Next, the skin depth depending on the specific resistance may be determined by the following Equation 2.

$$δ = \sqrt{\frac{2 ρ}{( 2 π f ) ( {μ}_{0} {μ}_{r} )}} \approx 503 \sqrt{\frac{ρ}{{μ}_{r} f}} \qquad [ Equation 2 ]$$

In the above Equation 2, 5 is skin depth, ρ is a specific resistance, μ₀ is permeability in a vacuum state, μᵣ is a relative permeability, and f is a frequency of a current.

In the above Equation 2, since μᵣ is a value substantially determined by a material, the skin depth may be determined by the specific resistance and the frequency.

As seen in the above Equation 1, the specific resistance may increase in proportion to the temperature and the skin depth may increase in proportion to the increase in the specific resistance.

That is, it can be appreciated that the skin depth increases in accordance with the increase in the temperature of the wire.

The following Table 1 shows a change in a skin depth depending on a temperature of copper (Cu) and a distribution of nanoparticles in terms of size, depending on the change.

TABLE 1

| | | Absolute | Specific | Skin | Particle | Particle |
|---|---|---|---|---|---|---|
| | Temperature | temperature | resistance | depth | distribution | distribution |
| | (° C.) | (k) | (ohm · m, 10⁻⁸) | (mm) | (r: 0.1 mm) | (r: 0.15 mm) |
| Normal | 20 | 293 | 1.68 | 0.0652 | X | X |
| temperature | | | | | | |
| 0.1 Tm | 108.5 | 381.5 | 2.96 | 0.0825 | X | X |
| 0.3 Tm | 325.5 | 598.5 | 5.17 | 0.114 | ◯ | X |
| 0.5 Tm | 542.5 | 815.5 | 7.65 | 0.139 | ◯ | X |
| 0.8 Tm | 868.0 | 1141.0 | 11.37 | 0.170 | ◯ | ◯ |
| 0.9 Tm | 976.5 | 1249.5 | 12.6 | 0.179 | — | — |
| 1.0 Tm | 1085 | 1385 | — | | — | — |

Tm: Melting point
r: Radius of wire

A particle distribution was represented by O in the case in which particles having a nanoparticle size are formed in an amount of 80% or more and was represented by X in the case in which the particles are less than 80%.

As seen in Table 1, it can be appreciated that in the case in which the radius r of the wire is 0.1 mm, when the temperature is 0.3 Tm or more, the skin depth becomes deeper as compared with the radius r of the wire.

Therefore, it could be appreciated that since the electricity uniformly flows to the wire depending on the depth, when the energy is applied after the wire is pre-heated to 0.3 Tm or more, a particle distribution of the formed particles is uniform.

However, at a temperature of 0.9 Tm or more, it is difficult to perform a pulsed wire discharge method due to a phase change of the wire.

Therefore, in order to form nanoparticles having a uniform particle distribution, in the case in which the radius r of the wire is 0.1 mm, after the wire is preheated to 0.3 Tm or more to 0.8 Tm or less, the applying of the energy to the wire using the power supply (S140) is performed, whereby the nanoparticles having a uniform particle distribution may be formed.

In addition, it can be appreciated that in the case in which the radius r of the wire is 0.15 mm, when the temperature is 0.8 Tm or more, the skin depth becomes deeper as compared with the radius r of the wire.

Therefore, it can be appreciated that since the electricity uniformly flows in the wire, depending on the depth, when the energy is applied after the wire is pre-heated to 0.8 Tm or more, a particle distribution of the formed particles is uniform.

However, at a temperature of 0.9 Tm or more, it is difficult to perform a pulsed wire discharge method due to a phase change of the wire.

In addition, at a temperature of 1.0 Tm, a melting point temperature, it is difficult to measure a specific resistance due to a phase change in the wire.

Therefore, in order to form nanoparticles having a uniform particle distribution, in the case in which the radius r of the wire is 0.15 mm, after the wire is preheated to 0.8 Tm, the applying of the energy to the wire using the power supply (S140) is performed, whereby the nanoparticles having a uniform particle distribution may be formed.

According to the embodiment of the present invention, the applying of the energy to the wire using the power supply to form the nano-sized particle (S140) may be performed under a nitrogen, oxygen, or inert gas atmosphere.

That is, the nanoparticles formed by creating a corresponding gas atmosphere in order to create an oxide, a nitride, or the like, and then applying the energy, may become the oxide or the nitride.

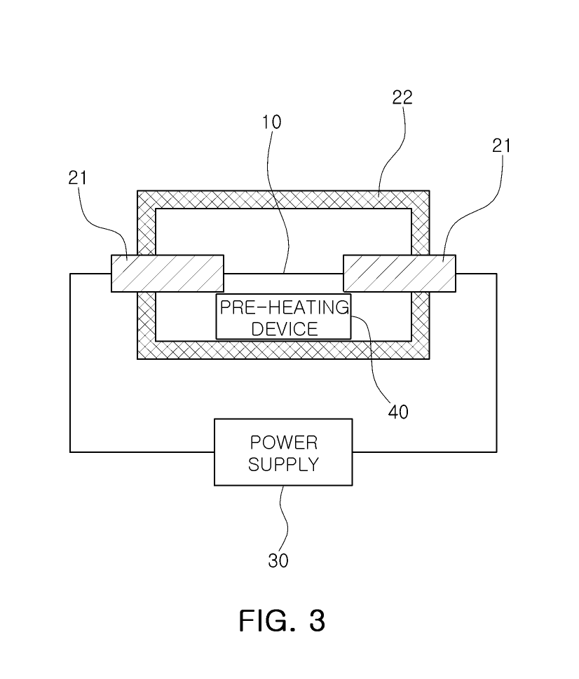

FIG. 3 is a schematic configuration diagram of a device for forming a nanoparticle according to another embodiment of the present invention.

A configuration of the device for forming a nanoparticle according to another embodiment of the present invention will be described with reference to FIG. 3. The device for forming a nanoparticle according to another embodiment of the present invention may include: a wire 10 formed of a material for forming a nano-sized particle; first and second electrodes 21 and 22 electrically connected to the wire 10; a power supply 30 electrically connected to the first and second electrodes 21 and 22 and applying energy to the wire; and a pre-heating device 40 pre-heating the wire, wherein a skin depth of the wire 10 is larger than a radius of the wire 10.

As the power supply 30, a capacity having high capacitance is used, whereby electricity having a high voltage and a high current may be applied to the wire for a very short time.

The pre-heating device 40 may be at least one of a laser device, an infrared ray device, a coil, and a resistor.

In addition, the pre-heating device 40 may be formed using a capacitor having a capacitance less than that of the power supply 30.

The device for forming a nanoparticle according to another embodiment of the present invention may further include a gas chamber 50 sealing the wire 10.

The gas chamber 50 may maintain a gas atmosphere such as nitrogen, oxygen, or the like, or be filled with an inert gas to prevent an unnecessary oxide or nitride from being created.

In addition, the gas chamber 50 may be maintained at a constant temperature when the pre-heating device 40 pre-heats the wire 10, thereby assisting in making a temperature of the wire 10 uniform.

As set forth above, with the method of forming a nanoparticle according to the embodiment of the present invention, since the skin depth of the wire is larger than the radius of the wire, the distribution of the energy applied to the entire wire may be uniform.

Therefore, when the nanoparticles are formed through an explosion of the wire, since uniform energy is applied to the entire wire, nanoparticles having a constant size may be formed.

While the present invention has been shown and described in connection with the embodiments, it will be apparent to those skilled in the art that modifications and variations can be made without departing from the spirit and scope of the invention as defined by the appended claims.

What is claimed is:

1. A method of forming a nanoparticle comprising:
preparing a wire formed of a material for forming a nano-sized particle;
connecting the wire to first and second electrodes;
pre-heating the wire using a pre-heating device; and
applying energy to the wire using a power supply to form the nano-sized particle,
wherein after the pre-heating is performed, a skin depth of the wire is larger than a radius of the wire.

2. The method of claim 1, wherein in the pre-heating, in the case that the radius of the wire is 0.15 mm, the wire is pre-heated to a temperature of 0.8 Tm.

3. The method of claim 1, wherein in the pre-heating, in the case that the radius of the wire is 0.10 mm, the wire is pre-heated to a temperature of 0.3 to 0.8 Tm.

4. The method of claim 1, wherein the applying of the energy to the wire using the power supply to form the nano-sized particle is performed by applying energy having a frequency of 1 MHz.

5. The method of claim 1, wherein the applying of the energy to the wire using the power supply to form the nano-sized particle is performed under a nitrogen, oxygen, or inert gas atmosphere.

6. The method of claim 1, wherein the wire is a metal or a semiconductor.

7. A device for forming a nanoparticle comprising:
a wire formed of a material for forming a nano-sized particle;
first and second electrodes electrically connected to the wire;
a power supply electrically connected to the first and second electrodes and applying energy to the wire; and
a pre-heating device pre-heating the wire,
wherein a skin depth of the wire is larger than a radius of the wire.

8. The device of claim 7, wherein in the case that the radius of the wire is 0.15 mm, a temperature of the wire is 0.8 Tm.

9. The device of claim 7, wherein in the case that the radius of the wire is 0.10 mm, a temperature of the wire is 0.3 to 0.8 Tm.

10. The device of claim 7, wherein the pre-heating device is at least one of a laser device, an infrared ray device, a coil, and a resistor.

11. The device of claim 7, wherein the energy applied from the power supply has a frequency of 1 MHz.

12. The device of claim 7, wherein the wire is a metal or a semiconductor.

13. The device of claim 7, further comprising a gas chamber sealing the wire.
